(19) United States
(12) Patent Application Publication
(10) Pub. No.: US 2011/0285687 A1
(43) Pub. Date: Nov. 24, 2011

(54) LIQUID CRYSTAL DISPLAY DEVICE AND ELECTRONIC DEVICE

(75) Inventors: Atsushi UMEZAKI, Isehara (JP); Hiroyuki MIYAKE, Atsugi (JP)

(73) Assignee: SEMICONDUCTOR ENERGY LABORATORY CO., LTD., Kanagawa-ken (JP)

(21) Appl. No.: 13/108,320

(22) Filed: May 16, 2011

(30) Foreign Application Priority Data
May 21, 2010 (JP) 2010-117017

(51) Int. Cl. G09G 3/36; G06F 3/038

(52) U.S. Cl. 345/211; 345/98

(57) ABSTRACT

To reduce the amplitude voltage of a scan signal of a scan line in common inversion driving. A liquid crystal display device includes a first transistor including a gate electrically connected to a first scan line, a first terminal electrically connected to a signal line, and a second terminal electrically connected to a first electrode of a liquid crystal element, and a second transistor including a gate electrically connected to a second scan line, a first terminal electrically connected to the signal line, and a second terminal electrically connected to a second electrode of the liquid crystal element. The signal line supplies a video signal for the inversion driving of the liquid crystal element to the first electrode through the first transistor and a common potential for the inversion driving of the liquid crystal element to the second electrode through the second transistor.

### BACKGROUND OF THE INVENTION

1. Field of the Invention

The present invention relates to liquid crystal display devices. Further, the present invention relates to a method for driving a liquid crystal display device. Furthermore, the present invention relates to electronic devices including the liquid crystal display devices.

2. Description of the Related Art

The use of liquid crystal display devices is steadily increasing in applications ranging from large display devices such as television receivers to small display devices such as mobile phones. From now on, products with higher added values will be needed and are being developed. In recent years, for high image quality and high added values, a liquid crystal material exhibiting a blue phase (hereinafter, blue-phase liquid crystal) has attracted attention. Blue-phase liquid crystal can respond to an electric field at very high speed in comparison with conventional liquid crystal materials and is expected to be used for a liquid crystal display device necessarily driven at high frame frequency (e.g., a liquid crystal display device for displaying a stereoscopic (3D) image).

Patent Document 1 discloses an IPS (in-plane switching) mode as a method for driving a blue-phase liquid crystal device. Patent Document 1 particularly discloses a structure of electrodes between which a liquid crystal material is provided, for reducing in voltage for driving a liquid crystal element.

### [Reference]

### [Patent Document 1] Japanese Published Patent Application No. 2007-271839.

### SUMMARY OF THE INVENTION

An IPS (in-plane switching) mode, which is described in Patent Document 1 and is a method for driving a blue-phase liquid crystal element, has a problem of high driving voltage. A cause of need for the high driving voltage is described below with reference to drawings.

FIG. 13A illustrates a circuit configuration of a pixel included in a liquid crystal display device. A pixel 1500 includes a transistor 1501, a liquid crystal element 1502, and a storage capacitor 1503. A video signal is input to a video signal line 1504 (also referred to as a data line, a source line, or a data signal line), and a gate signal (also referred to as a scan signal or a selection signal) is input to a scan line 1505. Further, a common potential is input to a common potential line 1506 (also referred to as a common line), and a fixed potential is input to a capacitor line 1507. Note that for convenience of description, an electrode of the liquid crystal element 1502 which is connected to the transistor 1501 is referred to as a first electrode (also referred to as a pixel electrode), and the other electrode of the liquid crystal element 1502 which is connected to the common potential line 1506 is referred to as a second electrode (also referred to as a counter electrode).

FIG. 13B illustrates an example of a timing diagram for illustrating operation of the pixel 1500 in FIG. 13A, in which inversion driving is performed. FIG. 13B shows a timing diagram of the potentials of a scan line GL, a signal line SL, a common potential line CL, the first electrode PE, and the second electrode CE in one frame of each of an inversion driving period 1511 and a non-inversion driving period 1512 of the inversion driving.

In FIG. 13B, the potential of a scan signal of the scan line GL is Vgh in a period for selecting a pixel, that is, a period for turning on the transistor 1501, and is Vgl in the other period, that is, a period for turning off the transistor 1501 (Vgh>Vgl). Further, the potential of the signal line SL varies in accordance an image to be displayed. Here, the potential for non-inversion driving is Vdh, and the potential for the inversion driving is Vdl (Vdh>Vdl). Note that although in FIG. 13B, the potential PE of the first electrode varies depending on the grayscale of a video signal of the signal line SL, for convenience of description, Vdh and Vdl are inverted in accordance with the scan signal of the scan line GL. In addition, in FIG. 13B, the potential of the common potential line CL, that is, the potential CE of the second electrode is Vc.

Gate line inversion driving is an example of the inversion driving, in which a video signal having a potential higher than that of the second electrode and a video signal having a potential lower than that of the second electrode alternate in being input to a pixel row. Source line inversion driving is driving in which the potential of a video signal higher than that of the second electrode and the potential of the video signal lower than that of the second electrode alternate in being input to a pixel column. Dot inversion driving is driving in which the potential of a video signal higher than that of the second electrode and the potential of the video signal lower than that of the second electrode are alternate in being input to a pixel row and a pixel column.

With a driving method employing inversion driving described with reference to FIG. 13B, the amplitude voltage of the video signal is high and power consumption is high. Thus, as a technique for reducing the amplitude voltage of the video signal and power consumption, common inversion driving in which the potentials CE of the second electrode are inverted every predetermined period (e.g., every frame period) is known.

FIG. 13C illustrates an example of a timing diagram for illustrating operation of the pixel 1500 in which the common inversion driving is performed. FIG. 13C is different from FIG. 13B because the potentials CE of the second electrode are inverted depending on whether the operation is in the inversion driving period 1511 or in the non-inversion driving period 1512 in FIG. 13C. In a driving method in FIG. 13C, the potential of the video signal is lower than the potential CE of the second electrode (Vdl) in a frame in which the potential CE of the second electrode is in a high level (Vch). Further, the potential of the video signal is higher than the potential CE of the second electrode (Vdh) in a frame in which the potential CE of the second electrode is in a low level (Vcl). In this manner, in comparison with the driving method described with reference to FIG. 13B, the amplitude voltage of the video signal can be reduced by half. Accordingly, the amplitude voltage of the video signal can be lower and power consumption can be reduced.

In the common inversion driving in FIG. 13C, the potential PE of the first electrode varies because of capacitive coupling when the potentials CE of the second electrode are inverted. Accordingly, the potential PE of the first electrode is higher than or lower than that of the video signal. The potential of the scan signal of the scan line GL needs to have a large amplitude in order to hold such a potential PE of the first electrode. For example, the potential PE of the first electrode has approximately the maximum value Vdh of the video signal. At this time, when the potentials CE of the second electrode are inverted from a low level (Vcl) to a high level (Vch), the potential PE of the first electrode has a value (Vdh+ΔV) which is a value higher than the maximum value Vdh of the video signal. The case where the potential PE of the first electrode has approximately the minimum value Vdl of the video signal is also described. At this time, when the potential CE of the second electrode is inverted from a high level (Vch) to a low level (Vcl), the potential PE of the first electrode has a value (Vdl−ΔV) which is a value lower than the minimum value Vdl of the video signal. Therefore, in order to turn off the transistor 1501, a low level of the potential (Vgl) of the scan signal of the scan line GL needs to be set lower than the potential (Vdl−ΔV) of the first electrode PE which is lower than the minimum value Vdl of the video signal. As a result, even with the common inversion driving, it is difficult to reduce the amplitude voltage of the scan signal of the scan line GL sufficiently.

In addition, in the common inversion driving illustrated in FIG. 13C, in order to prevent variations in the potential PE of the first electrode caused by capacitive coupling when the potentials CE of the second electrode are inverted, a capacitor can be added to the first electrode PE side in the circuit configuration in FIG. 13A. However, with the circuit configuration in FIG. 13A in which the potentials of the second electrodes CE in all of the pixels are inverted at the same time, in the case where a capacitor is additionally provided on the first electrode PE side so that the potential PE of the first electrode does not vary because of capacitive coupling, a display defect is caused after the potentials of the second electrodes CE of all of the pixels are inverted and until the potential of the video signal is written to the first electrodes PE of all of the pixels (within approximately one frame period). Specifically, the voltage between the first electrode PE the potential of which varies and the second electrode, the potentials of which are inverted, is applied to a liquid crystal element for approximately one frame period, so that the voltage different from that of the video signal is applied to the liquid crystal element; therefore, a display defect is caused.

In particular, when a liquid crystal mode, driving voltage of which is high, is used; it is the problem that the amplitude voltage of the scan signal of the scan line GL cannot be made to be sufficiently low with the common inversion driving. For example, the driving voltage of a liquid crystal material exhibiting a blue phase (hereinafter, blue-phase liquid crystal) is approximately +20V to −20V In other words, the amplitude voltage of the video signal is approximately 40V and the amplitude voltage of the scan signal of the scan line GL is necessarily 40V or more (e.g., approximately 50V). Therefore, a high voltage is applied between a source or drain and a gate of a transistor to which a high voltage is applied, e.g., a transistor included in a pixel. Accordingly, a problem such as variation in characteristics of the transistor, deterioration in characteristics of the transistor, or a breakdown of the transistor itself is caused.

Thus, it is an object of an embodiment of the present invention to provide a liquid crystal display device in which the common inversion driving by which the amplitude voltage of a scan signal of a scan line can be low is performed.

An embodiment of the present invention is a liquid crystal display device including a first transistor including a gate electrically connected to a first scan line, a first terminal electrically connected to a signal line, and a second terminal electrically connected to a first electrode of a liquid crystal element, a second transistor including a gate electrically connected to a second scan line, a first terminal electrically connected to the signal line, and a second terminal electrically connected to a second electrode of the liquid crystal element. A video signal for inversion driving of the liquid crystal element is supplied from the signal line to the first electrode throught the first transistor, and a common potential for the inversion driving of the liquid crystal element is supplied from the signal line to the second electrode through the second transistor.

An embodiment of the present invention is a liquid crystal display device including a first transistor including a gate electrically connected to a first scan line, a first terminal electrically connected to a signal line, and a second terminal electrically connected to a first electrode of a liquid crystal element, a second transistor including a gate electrically connected to a second scan line, a first terminal electrically connected to the signal line, and a second terminal electrically connected to a second electrode of the liquid crystal element, and a capacitor including the first electrode and a capacitor wiring. A video signal for inversion driving of the liquid crystal element is supplied from the signal line to the first electrode throught the first transistor, and a common potential for the inversion driving of the liquid crystal element is supplied from the signal line to the second electrode through the second transistor.

An embodiment of the present invention is a liquid crystal display device including a first transistor including a gate electrically connected to a first scan line, a first terminal electrically connected to a signal line, and a second terminal electrically connected to a first electrode of a liquid crystal element, a second transistor including a gate electrically connected to a second scan line, a first terminal electrically connected to the signal line, and a second terminal electrically connected to a second electrode of the liquid crystal element, and a capacitor including the second electrode and a capacitor wiring. A video signal for inversion driving of the liquid crystal element is supplied from the signal line to the first electrode throught the first transistor, and a common potential for the inversion driving of the liquid crystal element is supplied from the signal line to the second electrode through the second transistor.

An embodiment of the present invention is a liquid crystal display device including a first transistor including a gate electrically connected to a first scan line, a first terminal electrically connected to a signal line, and a second terminal electrically connected to a first electrode of a liquid crystal element, and a second transistor including a gate electrically connected to a second scan line, a first terminal electrically connected to a common potential line, and a second terminal electrically connected to a second electrode of the liquid crystal element. A video signal for inversion driving of the liquid crystal element is supplied from the signal line to the first electrode through the first transistor. A common potential for the inversion driving of the liquid crystal element is supplied from the common potential line to the second electrode through the second transistor.

An embodiment of the present invention may be the liquid crystal display device in which a switching element controls the signal line by switching connection of the signal line to the video signal line or to the common potential line.

An embodiment of the present invention may be the liquid crystal display device in which the inversion driving is performed in such a manner that the video signal with polarity differing between the scan lines is applied to the liquid crystal element.

An embodiment of the present invention may be the liquid crystal display device in which the inversion driving is performed in such a manner that the video signal with polarity differing between the signal lines is applied to the liquid crystal element.

According to an embodiment of the present invention, a liquid crystal display device in which the common inversion driving by which the amplitude voltage of a scan signal of a scan line can be low and low power consumption can be achieved can be provided.

### BRIEF DESCRIPTION OF THE DRAWINGS

FIG. 1A is a circuit diagram and FIG. 1B is a timing diagram of an embodiment of the present invention.

FIG. 2A is a circuit diagram and FIG. 2B is a timing diagram of an embodiment of the present invention.

FIG. 3 is a timing diagram of an embodiment of the present invention.

FIGS. 4A and 4C are timing diagrams and FIG. 4B is a circuit diagram of an embodiment of the present invention.

FIG. 5 is a circuit diagram of an embodiment of the present invention.

FIG. 6 is a circuit diagram of an embodiment of the present invention.

FIGS. 7A and 7C are circuit diagrams and FIG. 7B is a block diagram of an embodiment of the present invention.

FIG. 8A is a circuit diagram, FIG. 8B is a timing diagram, and FIG. 8C is a schematic diagram of an embodiment of the present invention.

FIGS. 9A and 9B are schematic diagrams and FIG. 9C is a timing diagram of an embodiment of the present invention.

FIG. 10A is a top view and FIG. 10B is a cross sectional view of an embodiment of the present invention.

FIGS. 11A to 11D are cross sectional views of an embodiment of the present invention.

FIGS. 12A to 12D are diagrams for illustrating electronic devices of an embodiment of the present invention.

FIG. 13A is a circuit diagram for illustrating inversion driving and FIGS. 13B and 13C are timing diagrams.

### DETAILED DESCRIPTION OF THE INVENTION

Hereinafter, embodiments of the present invention will be described with reference to the accompanying drawings. However, the present invention can be carried out in many different modes, and it is easily understood by those skilled in the art that modes and details of the present invention can be modified in various ways without departing from the purpose and the scope of the present invention. Therefore, this invention is not interpreted as being limited to the description of the embodiments below. Note that identical portions or portions having the same function in all drawings illustrating the structure of the invention that is described below are denoted by the same reference numerals.

Note that the size, the thickness of a layer, the waveform of a signal, and a region of each structure illustrated in the drawings and the like in the embodiments are exaggerated for simplicity in some cases. Therefore, embodiments of the present invention are not necessarily limited to such scales.

Note that in this specification, terms such as “first”, “second”, “third”, and

“N-th” (N is a natural number) are used in order to avoid confusion among components and do not limit the components numerically.

### Embodiment 1

In this embodiment, a structure of a pixel in a liquid crystal display device and signals for driving the liquid crystal display device will be described with reference to circuit diagrams and timing diagrams.

Note that described is an example in the case of using blue-phase liquid crystal as a liquid crystal element of this embodiment. Blue-phase liquid crystal is liquid crystal driven by a horizontal electrical field mode; a liquid crystal element is formed in the following manner: a common electrode corresponding to a second electrode of a liquid crystal element is formed over the same substrate as a pixel electrode corresponding to a first electrode of the liquid crystal element. Note that a structure of this embodiment can be used not only for a liquid crystal element including blue-phase liquid crystal but also for a liquid crystal element including liquid crystal driven by a horizontal electrical field mode, or a liquid crystal element with the first electrode and the second electrode provided over the same substrate.

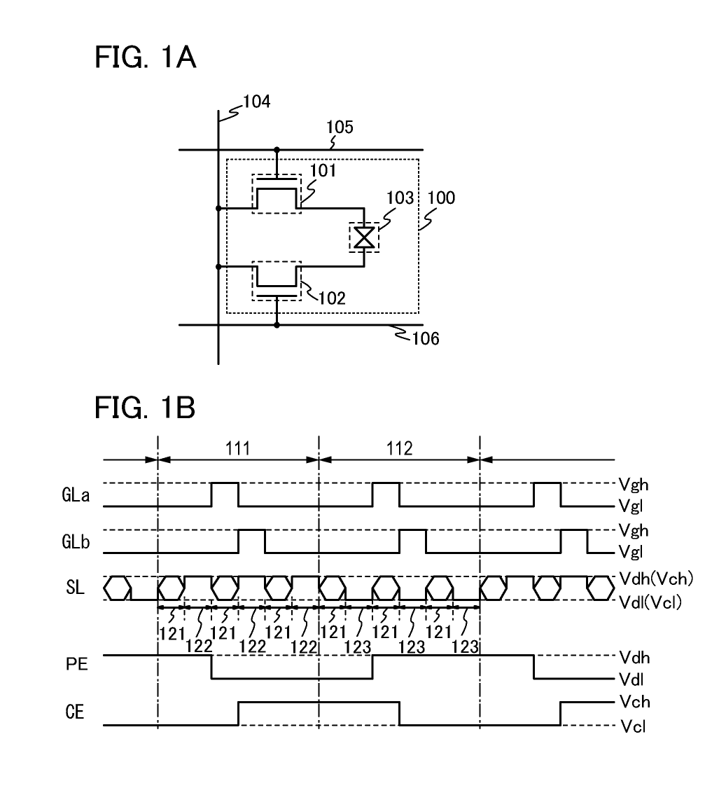

FIG. 1A illustrates an example of a circuit diagram of a pixel. A pixel 100 includes a first transistor 101, a second transistor 102, and a liquid crystal element 103.

A first terminal of the first transistor 101 is connected to a signal line 104. A gate of the first transistor 101 is connected to a first scan line 105. A second terminal of the first transistor 101 is connected to a first electrode (also referred to as a pixel electrode) of the liquid crystal element 103. A first terminal of the second transistor 102 is connected to the signal line 104. A gate of the second transistor 102 is connected to a second scan line 106. A second terminal of the second transistor 102 is connected to a second electrode (also referred to as a common electrode) of the liquid crystal element 103.

The grayscale of each pixel for displaying an image is expressed in the following manner: the potential of the first electrode of the liquid crystal element 103 and the potential of the second electrode of the liquid crystal element 103 vary to control voltage applied to liquid crystal provided between the first electrode and the second electrode of the liquid crystal element 103. The potential of the first electrode is controlled by controlling a video signal supplied to the signal line 104, and the potential of the second electrode is controlled by controlling a common potential supplied to the signal line 104. The potential of the video signal of the signal line 104 is supplied to the first electrode of the liquid crystal element 103 by turning on the first transistor 101. The common potential of the signal line 104 is supplied to the second electrode of the liquid crystal element 103 by turning on the second transistor 102. In other words, the video signal and the common potential for inversion driving of the liquid crystal element 103 are supplied from the signal line 104 to the first electrode and second electrode, respectively, of the liquid crystal element 103 in separate periods in such a manner that the video signal is supplied through the first transistor 101 and the common potential is supplied through the second transistor 102.

Note that a pixel is a display unit which can control the brightness of one color component (e.g., one of R (red), G (green), and B (blue)). Accordingly, in the case of a color display device, a minimum display unit of a color image is formed of three pixels: an R pixel, a G pixel, and a B pixel. Note that the color elements for displaying a color image are not limited to three colors, and color elements of more than three colors may be used or a color other than RGB may be used.

Note that a transistor is an element having at least three terminals of gate, drain, and source. The transistor includes a channel region between a drain region and a source region, and current can flow through the drain region, the channel region, and the source region. Here, since the source and the drain of the transistor may change depending on the structure, the operating condition, and the like of the transistor, it is difficult to define which is a source or a drain. Thus, in this specification, a region functioning as a source and a drain may not be called the source or the drain. In such a case, for example, one of the source and the drain may be referred to as a first terminal and the other thereof may be referred to as a second terminal. Alternatively, one of the source and the drain may be referred to as a first electrode and the other thereof may be referred to as a second electrode. Further alternatively, one of the source and the drain may be referred to as a source region and the other thereof may be called a drain region.

Note that in this specification, the state where A and B are connected to each other includes the state where A and B are electrically connected to each other as well as the state where A and B are directly connected to each other. Here, the phrase “A is electrically connected to B” means, when an object having an electric function is placed between A and B, the case where a portion between A and B, which includes the object, can be considered as a node. Specifically, the description “A and B are connected” includes the case where a portion between A and B can be regarded as one node in consideration of circuit operation, for example, the case where A and B are connected through a switching element such as a transistor and have the same or substantially the same potentials by conduction of the switching element, and the case where A and B are connected through a resistor and the potential difference generated at opposite ends of the resistor does not adversely affect the operation of a circuit including A and B.

Note that voltage refers to a potential difference between a given potential and a reference potential (e.g., a ground potential) in many cases. Accordingly, voltage, potential and a potential difference can be referred to as potential, voltage, and a voltage difference, respectively.

The structure of the transistor provided in the pixel may be an inverted-staggered structure or a staggered structure. Alternatively, a double-gate structure may be used in which a channel region is divided into a plurality of regions and the divided channel regions are connected in series. Alternatively, a dual-gate structure may be used in which gate electrodes are provided over and under the channel region. Further, the transistor element may be used in which a semiconductor layer is divided into a plurality of island-shaped semiconductor layers and which realizes switching operation.

FIG. 1B is an example of a timing diagram for illustrating operation of the pixel 100 in FIG. 1A. In FIG. 1B, GLa denotes the potential of the first scan line 105, GLb denotes the potential of the second scan line 106, SL denotes the potential of the signal line 104, PE denotes the potential of the first electrode, and CE denotes the potential of the second electrode. Further, a period 111 is an inversion driving period in which the liquid crystal element 103 is driven by the inversion driving, and a period 112 is a non-inversion driving period in which the liquid crystal element 103 is driven by the non-inversion driving. The period 111 and the period 112 are each corresponds to one frame period.

In FIG. 1B, the potential GLa of the second scan line 105 is Vgh in the period in which the video signal of the signal line 104 is supplied to the first electrode of the pixel, that is, a period in which the first transistor 101 is turned on, and the potential GLa is Vgl in the other period, that is, a period in which the first transistor 101 is turned off (Vgh>Vgl). Further, in FIG. 1B, the potential GLb of the second scan line 106 is Vgh in the period in which the common potential of the signal line 104 is supplied to the second electrode of the pixel, that is, a period in which the first transistor 102 is turned on, and is Vgl in the other period, that is, a period in which the first transistor 102 is turned off (Vgh>Vgl).

The period 121 and the period 122 are a period in which the signal line 104 is supplied with the video signal and a period in which the signal line 104 is supplied with the common potential, respectively.

The potential of the video signal varies in accordance with an image to be displayed, and here, the potential for the non-inversion driving is Vdh and the potential for the inversion driving is Vdl (Vdh>Vdl). Note that in FIG. 1B, the potential PE of the first electrode varies in accordance with the grayscale of the video signal of the signal line 104. For convenience of description, the potential PE of the first electrode becomes Vdh or Vdl in accordance with a scan signal of the first scan line 105. In addition, the common potential is the potential Vch, which is the same as the potential (Vdh) for making a liquid crystal element perform the non-inversion driving, in the period 111 for the inversion driving, and is the potential Vcl, which is the same as the potential of the first electrode (Vdl) for making the liquid crystal element perform the inversion driving, in the period 112 for performing the non-inversion driving.

In other words, in the period 111 shown in FIG. 1B, the signal line 104 is supplied with the video signal in a period in which the first transistor 101 is turned on by selecting the first scan line 105 of each row (a period 121 in FIG. 1B), and the signal line 104 is supplied with the common potential Vch for performing the inversion driving in a period in which the second transistor 102 is turned on by selecting the second scan line 106 (a period 122 in FIG. 1B). In the period 112 shown in FIG. 1B, the signal line 104 is supplied with the video signal in a period in which the first transistor 101 is turned on by the first scan line 105 of each row (the period 121 in FIG. 1B), and supplied with the common potential Vcl for performing the non-inversion driving in a period in which the second transistor 102 is turned on by the second scan line 106 (a period 123 in FIG. 1B).

By the above-described signals of the first scan line 105, the second scan line 106, and the signal line 104, the potential PE of the first electrode becomes Vdl at the timing when the potential GLa of the second scan line 105 becomes Vgh in the period 111, and the potential PE of the first electrode becomes Vdh at the timing when the potential GLa of the second scan line 105 becomes Vgh in the period 112. In addition, the potential CE of the second electrode becomes Vch at the timing when the potential GLb of the second scan line 106 becomes Vgh in the period 111, and the potential CE of the second electrode becomes Vcl at the timing when the potential GLb of the second scan line 106 becomes Vgh in the period 112.

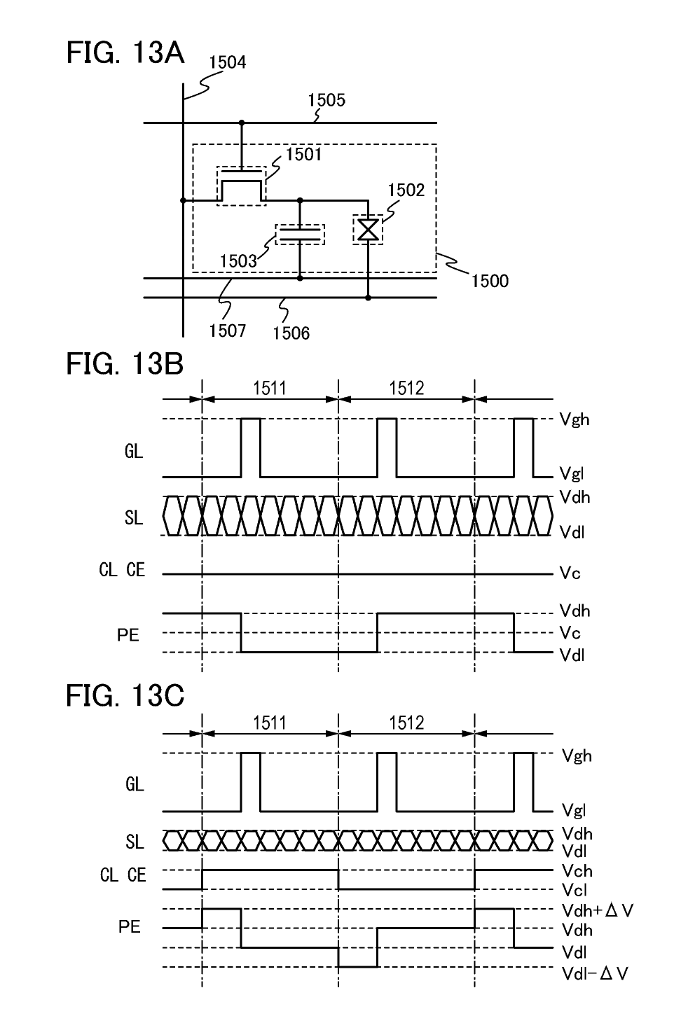

With the inversion driving in which the potentials CE of the second electrode and the polarities of the image singal are inverted, the amplitude voltage of the video signal can be reduced by approximately half as in the driving method described with reference to FIG. 13C. Accordingly, the amplitude voltage of the video signal can be low and reduction in power consumption can be reduced.

As illustrated in FIG. 1B, in the period 111, the potential GLa of the second scan line 105 becomes Vgh, and then, the potential GLb of the second scan line 106 becomes Vgh. The first transistor 101 enables the potential of the video signal to be supplied to the first electrode in the period 121, and the second transistor 102 allows the common potential Vch to be supplied to the second electrode in the period 122. Further, in the period 112, as in the period 111, the potential GLa of the second scan line 105 becomes Vgh, and then, the potential GLb of the second scan line 106 becomes Vgh. The first transistor 101 enables the potential of the video signal to be supplied to the first electrode in the period 121, and the second transistor 102 enables the common potential Vcl to be supplied to the second electrode in the period 123. In other words, the potential GLb of the second scan line 106 becomes Vgh after the period in which the potential GLa of the second scan line 105 becomes Vgh, and the potential Vdh of the video signal is supplied to the first electrode and the common potential Vch is supplied to the second electrode. The potential CE of the second electrode becomes the potential Vch of the common potential line after the period 121 in which the potential GLa of the second scan line 105 becomes Vgh.

As shown in FIG. 1B, in a structure of this embodiment, a period in which the potential GLb of the second scan line 106 becomes Vgh comes after a period in which the potential GLa of the second scan line 105 becomes Vgh, so that the first transistor 101 and the second transistor 102 can be sequentially turned on within a short period. Accordingly, in order to prevent variations in the potential PE of the first electrode caused by capacitive coupling when the potentials CE of the second electrode are inverted, it is preferable that a capacitor be additionally provided on the first electrode side in the circuit configuration in FIG. 1A. In other words, a capacitor is additionally provided on the first electrode side, so that the video signal and the common potential can be sequentially supplied to each pixel even when the potential PE of the first electrode is set not to vary because of the capacitive coupling. Thus, display defects can be reduced in comparison with the driving method illustrated in FIG. 13C. As a result, the circuit configuration in FIG. 1A and the driving as shown in FIG. 1B, so that a variation in the potential PE of the first electrode caused by the capacitive coupling in accordance with variation in the potential CE of the second electrode can be prevented.

As described above, in the pixel in FIG. 1A, by additionally providing a capacitor on the first electrode side, the potential PE of the first electrode does not vary because of the capacitive coupling even when the potentials CE of the second electrode are inverted; therefore, the amplitude voltage of the scan signals of the first scan line 105 and the second scan line 106 can be low unlike in the driving method described with reference to FIG. 13C.

Then, a circuit configuration including a capacitor provided to hold the potential PE of the first electrode in addition to the circuit configuration in FIG. 1A is illustrated, and an advantage of common inversion driving according to an embodiment of the present invention, in which the amplitude voltage of the scan signal of the scan line can be reduced and power consumption can be lowered, is described.

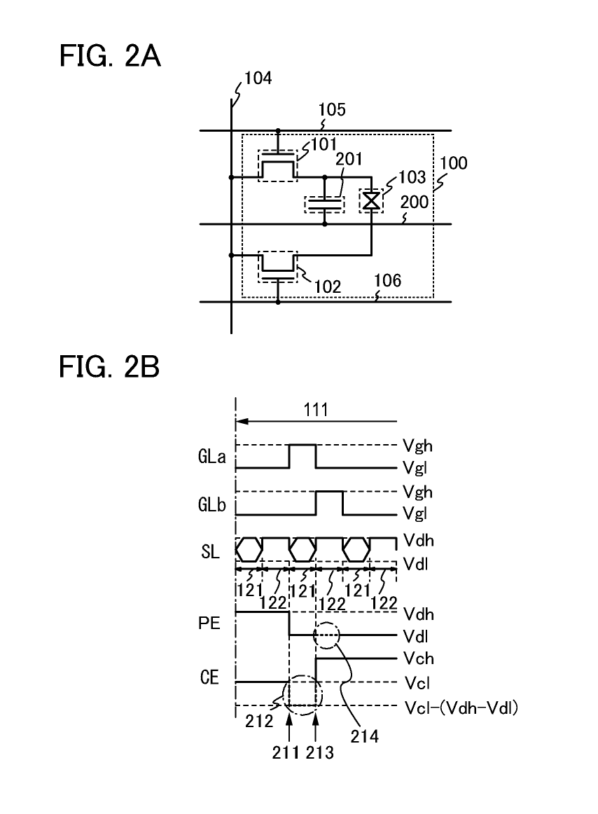

FIG. 2A shows a structure in which the capacitor wiring 200 and a capacitor 201 having the first electrode and the capacitor wiring 200, which are one electrode and the other electrode, are provided to the circuit configuration in FIG. 1A.

FIG. 2B illustrates an example of a timing diagram for explaining operation of the semiconductor device in FIG. 2A. The period 111 which is the inversion driving period illustrated in FIG. 1B is explained with reference to FIG. 2B.

In the circuit configuration in FIG. 2A, the potential PE of the first electrode varies from Vdh to Vdl at the timing when the potential GLa of the second scan line 105 becomes Vgh (an arrow 211 in FIG. 2B). At this time, the potential CE of the second electrode is in an electrically floating state because the second transistor 102 is off Accordingly, when the potential PE of the first electrode varies from Vdh to Vdl, the potential CE of the second electrode is decreased from Vcl by (Vdh−Vdl) at the maximum because of the capacitive coupling, and becomes the potential {Vc1−(Vdh−Vdl)} (an alternate long and short dashed line 212 in FIG. 2B). Then, at the timing when the potential GLb of the second scan line 106 becomes Vgh, the potential CE of the second electrode varies from {Vcl−(Vdh−Vdl)} to Vch (an arrow 213 in FIG. 2B). At this time, the potential PE of the first electrode is in an electrically floating state because the first transistor 101 is off. Thus, as illustrated in FIG. 2A, a capacitor is additionally provided on the first electrode side in order to prevent variation in the potential PE of the first electrode caused by the capacitive coupling (an alternate long and short dashed line 214 in FIG. 2B).

In the circuit configuration in FIG. 2A, the potential CE of the second electrode is decreased because of the capacitive coupling. However, in the circuit configuration in FIG. 2A, the video signal and the common potential can be sequentially supplied to each pixel, which is different from the circuit configuration in FIG. 13A in which the potentials CE of the second electrode are inverted in all of the pixels at the same time. Therefore, a period in a state represented by the alternate long and short dashed line 212 in FIG. 2B can be a period in which liquid crystal of a liquid crystal element little responds to an electric field.

The circuit configuration in FIG. 2A of this embodiment can include a capacitor in advance in order to prevent variation in the potential PE of the first electrode even when the potential CE of the second electrode varies. Therefore, even if the low level (Vgl) of each of the potential GLa of the second scan line 105 and the potential GLb of the second scan line 106 is (Vdl−Vth), the potential PE of the first electrode does not vary because of the capacitive coupling and does not need to be lower than (Vdl−Vth).

Thus, with the circuit configuration in FIG. 2A of this embodiment, the amplitude voltage of the scan signal of the first scan line 105 and the second scan line 106 can be low and power consumption can be low.

Note that as illustrated in FIG. 2A, with the structure in which the capacitor 201 is provided, the current supply capability of the first transistor 101 is preferably higher than that of the second transistor 102. Specifically, the ratio of the channel width (W) to the channel length (L) (W/L) of the first transistor 101 is larger than that of the second transistor 102. In the case where the W/L of the first transistor 101 is larger than that of the second transistor 102, the charging rate of the capacitor 201 can be high and rising edge of the potential of the first electrode can be sharp.

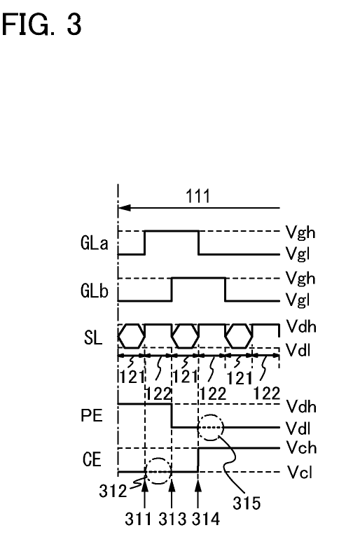

Note that in the timing diagram in FIG. 2B, the timing when the potential GLa of the second scan line 105 goes to a high level and the timing when the potential GLb of the second scan line 106 goes to a high level can be overlapped with each other when operation is performed. In other words, the first transistor 101 and the second transistor 102 can sometimes be on at the same time. A specific operation example is described with reference to FIG. 3. Note that in FIG. 3, operation in the period 111 which is the inversion driving period of the circuit configuration illustrated in FIG. 2A is described. Note that in FIG. 3, the potential Vdh of the video signal and the common potential Vch are the same potential, and the potential Vdl of the video signal and the common potential Vcl are the same potential.

In FIG. 3, at the timing when the potential GLa of the second scan line 105 becomes Vgh and the potential GLa of the second scan line 105 becomes Vgl, the potential PE of the first electrode is Vch (Vdh in the drawing, because Vch=Vdh) (an arrow 311 in FIG. 3). At this time, the potential CE of the second electrode is in an electrically floating state because the second transistor 102 is off. Accordingly, in the case where the potential PE of the first electrode varies, though the potential PE of the first electrode does not vary in the description with reference to FIG. 3, the potential CE of the second electrode varies by a variation in the potential PE of the first electrode because of the capacitive coupling (an alternate long and short dashed line 312 in FIG. 3). Then, at the timing when the potential GLa of the second scan line 105 and the potential GLb of the second scan line 106 become Vgh, the potential PE of the first electrode and the potential CE of the second electrode vary to Vdl (=Vcl) (an arrow 313 in FIG. 3). Then, at the timing when the potential GLa of the second scan line 105 becomes Vgl and the potential GLb of the second scan line 106 becomes Vgh, the potential CE of the second electrode varies to Vch (an arrow 314 in FIG. 3). At this time, the potential PE of the first electrode is in an electrically floating state because the first transistor 101 is off. Thus, as illustrated in FIG. 2A, a capacitor is additionally provided on the first electrode side in order to prevent the variation in the potential PE of the first electrode caused by the capacitive coupling (an alternate long and short dashed line 315 in FIG. 3).

As described above, the amplitude voltage of the scan signal of the scan line can be low. As a result, a voltage applied to a transistor connected to the scan line can be low, whereby variation in the characteristics of the transistor, deterioration in the characteristics of the transistor, a breakdown of the transistor, or the like can be prevented. Further, in the pixel described in this embodiment, one wiring functions as both a wiring for supplying the common potential and a wiring for supplying the video signal, whereby the number of wirings can be reduced. Therefore, there is an advantage in that the aperture ratio of the pixel can be improved.

This embodiment can be implemented in appropriate combination with any of the structures described in the other embodiments.

### Embodiment 2

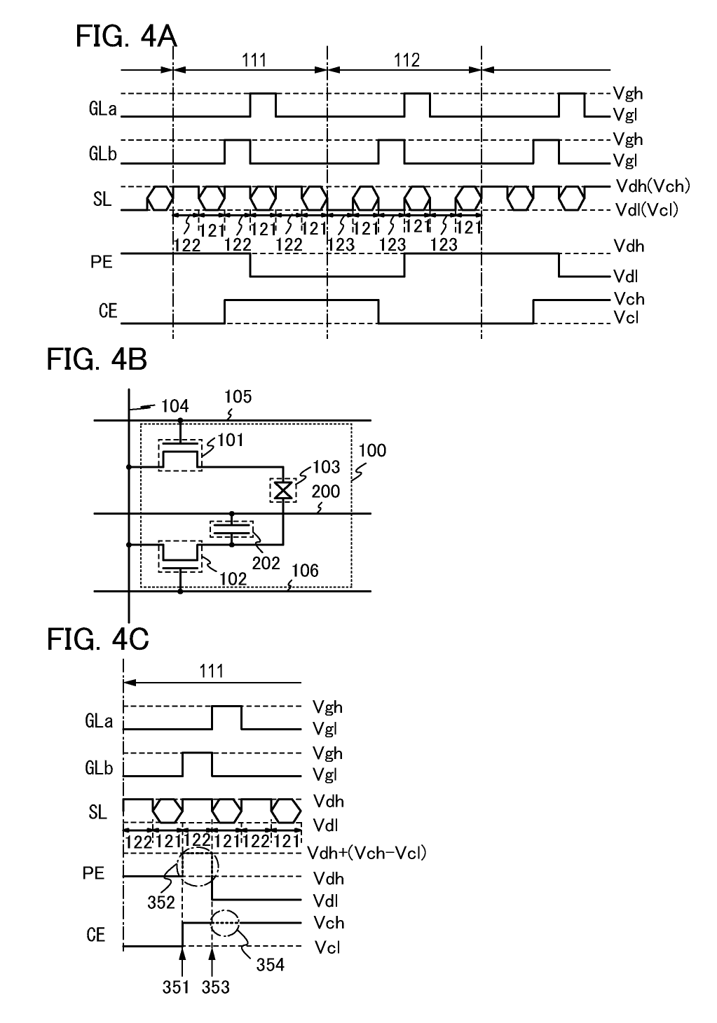

In this embodiment, an operation structure for driving the circuit illustrated in FIG. 1A will be described with reference to a timing diagram in FIG. 4A. The operation structure is different from that shown in Embodiment 1 with reference to the timing diagram in FIG. 1B. Note that the timing diagram in FIG. 4A is different from the timing diagram in FIG. 1B in that the timing when the potential GLa of the second scan line 105 becomes Vgh and the timing when the potential GLb of the second scan line 106 becomes Vgh are switched to each other.

FIG. 4A is an example of a timing diagram for illustrating operation of the pixel 100 in FIG. 1A. In FIG. 4A, GLa denotes the potential of the first scan line 105, GLb denotes the potential of the second scan line 106, SL denotes the potential of the signal line 104, PE denotes the potential of the first electrode, and CE denotes the potential of the second electrode. Further, a period 111 is an inversion driving period in which the liquid crystal element 103 is driven by the inversion driving, and a period 112 is a non-inversion driving period in which the liquid crystal element 103 is driven by the non-inversion driving. The period 111 and the period 112 are each corresponds to one frame period.

In FIG. 4A, the potential GLa of the second scan line 105 is Vgh in the period in which the video signal of the signal line 104 is supplied to a first electrode of a pixel, that is, a period in which the first transistor 101 is turned on, and is Vgl in the other period, that is, a period in which the first transistor 101 is turned off (Vgh>Vgl). Further, in FIG. 4A, the potential GLb of the second scan line 106 is Vgh in the period in which the common potential of the signal line 104 is supplied to a second electrode of the pixel, that is, a period in which the first transistor 102 is turned on, and is Vgl in the other period, that is, a period in which the first transistor 102 is turned off (Vgh>Vgl).

The potential SL of the signal line 104 is shown in FIG. 4A , and there are a period in which the signal line 104 is supplied with the video signal and a period in which the signal line 104 is supplied with the common potential.

The potential of the video signal varies in accordance with an image to be displayed, and here, the potential for the non-inversion driving is Vdh and the potential for the inversion driving is Vdl (Vdh>Vdl). Note that in FIG. 4A, the potential PE of the first electrode varies in accordance with the grayscale of the video signal of the signal line 104. For convenience of description, the potential PE of the first electrode becomes Vdh or Vdl in accordance with a scan signal of the first scan line 105. In addition, the common potential is the potential Vch, which is the same as the potential (Vdh) for making a liquid crystal element perform the non-inversion driving, in the period 111 for the inversion driving, and is the potential Vcl, which is the same as the potential of the first electrode (Vdl) for making the liquid crystal element perform the inversion driving, in the period 112 for performing the non-inversion driving.

In other words, in the period 111 shown in FIG. 4A, the signal line 104 is supplied with the video signal in a period in which the first transistor 101 is turned on by selecting the first scan line 105 of each row (the period 121 in FIG. 4A), and supplied with the common potential Vch for performing the inversion driving in a period in which the second transistor 102 is turned on by selecting the second scan line 106 (a period 122 in FIG. 4A). In the period 112 shown in FIG. 4A, the signal line 104 is supplied with the video signal in a period in which the first transistor 101 is turned on by the first scan line 105 of each row (the period 121 in FIG. 4A), and supplied with the common potential Vcl for performing the non-inversion driving in a period in which the second transistor 102 is turned on by the second scan line 106 (the period 123 in FIG. 4A).

By the above-described signals of the first scan line 105, the second scan line 106, and the signal line 104, the potential CE of the second electrode becomes Vch at the timing when the potential GLb of the second scan line 106 becomes Vgh in the period 111, and the potential CE of the second electrode becomes Vcl at the timing when the potential GLb of the second scan line 106 becomes Vgh in the period 112. In addition, the potential PE of the first electrode becomes Vdl at the timing when the potential GLa of the second scan line 105 becomes Vgh in the period 111, and the potential PE of the first electrode becomes Vdh at the timing when the potential GLa of the second scan line 105 becomes Vgh in the period 112.

With the inversion driving in which the potentials CE of the second electrode and the polarities of the image singal are inverted, the amplitude voltage of the video signal can be reduced by approximately half as in the driving method described with reference to FIG. 13C. Accordingly, the amplitude voltage of the video signal can be low and reduction in power consumption can be reduced.

As illustrated in FIG. 4A, in the period 111, the potential GLb of the second scan line 106 becomes Vgh, and then, the potential GLa of the first scan line 105 becomes Vgh. The second transistor 102 enables the common potential Vch to be supplied to the second electrode in the period 122, and the first transistor 101 enables the potential Vdl of the video signal to be supplied to the first electrode in the period 121. Further, in the period 112, as in the period 111, the potential GLb of the second scan line 106 becomes Vgh, and then, the potential GLa of the second scan line 105 becomes Vgh. The second transistor 102 enables the common potential Vcl to be supplied to the second electrode in the period 123, and the first transistor 101 enables the potential of the video signal Vdh to be supplied to the first electrode in the period 121. In other words, the potential GLa of the second scan line 105 becomes Vgh after the potential GLb of the second scan line 106 becomes Vgh, and the common potential Vch is supplied to the second electrode and the potential Vdh of the video signal is supplied to the first electrode. The potential PE of the first electrode becomes the potential Vdl of the video signal after the period 122 in which the potential GLb of the second scan line 106 becomes Vgh.

As shown in FIG. 4A, in a structure of this embodiment, a period in which the potential GLa of the second scan line 105 becomes Vgh comes after a period in which the potential GLb of the second scan line 106 becomes Vgh, so that the second transistor 102 and the first transistor 101 are sequentially turned on within a short period. Accordingly, in order to prevent variation in the potential CE of the second electrode caused by the capacitive coupling when the potential PE of the first electrode varies, it is preferable that a capacitor be additionally provided on the second electrode side in the circuit configuration in FIG. 1A. In other words, a capacitor is additionally provided on the second electrode side, so that the common potential and the video signal can be sequentially supplied to each pixel even when the potential CE of the second electrode is set not to vary because of the capacitive coupling; therefore, display defects can be reduced in comparison with the driving method illustrated in FIG. 13C. As a result, the circuit in FIG. 1A is driven in the way shown in FIG. 4A, so that variation in the potential CE of the second electrode caused by the capacitive coupling in accordance with variation in the potential of the video signal can be prevented.

As described above, in the pixel in FIG. 1A, by additionally providing a capacitor on the second electrode side, the potential CE of the second electrode does not vary because of the capacitive coupling even when the potentials of the signal line 104 SL are inverted; therefore, the amplitude voltage of the scan signals of the first scan line 105 and the second scan line 106 can be low unlike in the driving method described with reference to FIG. 13C.

Then, in the circuit configuration illustrated in FIG. 1A, a circuit configuration including a capacitor provided to hold the potential CE of the second electrode is illustrated, and an advantage of the common inversion driving according to an embodiment of the present invention, in which the amplitude voltage of the scan signal of the scan line can be reduced and power consumption can be lowered, is described.

FIG. 4B shows a structure in which the capacitor wiring 200 and a capacitor 202 having the second electrode and the capacitor wiring 200, which are one electrode and the other electrode, are provided to the circuit configuration in FIG. 1A.

Note that as illustrated in FIG. 4B, with the structure in which the capacitor 202 is provided, the current supply capability of the second transistor 102 is preferably larger than that of the first transistor 101. Specifically, the ratio of the channel width (W) to the channel length (L) (W/L) of the second transistor 102 is larger than that of the first transistor 101. In the case where the W/L of the second transistor 102 is larger than that of the first transistor 101, the charging rate of the capacitor 202 is high and rising edge of the potential of the second electrode can be sharp.

FIG. 4C is an example of a timing diagram for describing operation of the circuit structure in FIG. 4B. The period 111 which is the inversion driving period illustrated in FIG. 1B is explained with reference to FIG. 4C.

In the circuit configuration in FIG. 4B, at the timing when the potential GLb of the second scan line 106 becomes Vgh, the potential CE of the second electrode varies from Vcl to Vch (an arrow 351 in FIG. 4C). At this time, the potential PE of the first electrode is in an electrically floating state because the first transistor 101 is off. Accordingly, when the potential CE of the second electrode varies from Vcl to Vch, the potential PE of the first electrode is increased from Vdh by (Vch−Vcl) at the maximum because of the capacitive coupling, and becomes the potential {Vdh+(Vch−Vcl)} (an alternate long and short dashed line 352 in FIG. 4C). Then, at the timing when the potential GLa of the second scan line 105 becomes Vgh, the potential PE of the first electrode varies from {Vdh+(Vch−Vcl)} to Vdl (an arrow 353 in FIG. 4C). At this time, the potential CE of the second electrode is in an electrically floating state because the second transistor 102 is off. Thus, as illustrated in FIG. 4B, a capacitor is additionally provided on the second electrode side in order to prevent variation in the potential CE of the second electrode caused by the capacitive coupling (an alternate long and short dashed line 354 in FIG. 4C).

In the circuit configuration in FIG. 4B, the potential PE of the first electrode is decreased because of the capacitive coupling. However, in the circuit configuration in FIG. 4B, the video signal and the common potential can be sequentially supplied to each pixel as in FIG. 2A. Therefore, a period in a state represented by the alternate long and short dashed line 352 in FIG. 4C can be a period in which liquid crystal of a liquid crystal element little responds to an electric field.

The circuit configuration in FIG. 4B of this embodiment can include a capacitor in advance in order to prevent variation in the potential CE of the second electrode even when the potential PE of the first electrode varies. Therefore, even if the low level (Vgl) of each of the potential GLa of the second scan line 105 and the potential GLb of the second scan line 106 is (Vdl−Vth), the potential PE of the first electrode does not vary because of the capacitive coupling and does not need to be further lower than (Vdl−Vth). Therefore, with the circuit configuration in FIG. 4B of this embodiment, the amplitude voltage of the scan signal of the first scan line 105 and the second scan line 106 can be low and power consumption can be low.

This embodiment can be implemented in appropriate combination with any of the structures described in the other embodiments.

### Embodiment 3

In this embodiment, a pixel with a different structure from that described in Embodiment 1 with reference to FIG. 1A will be explained.

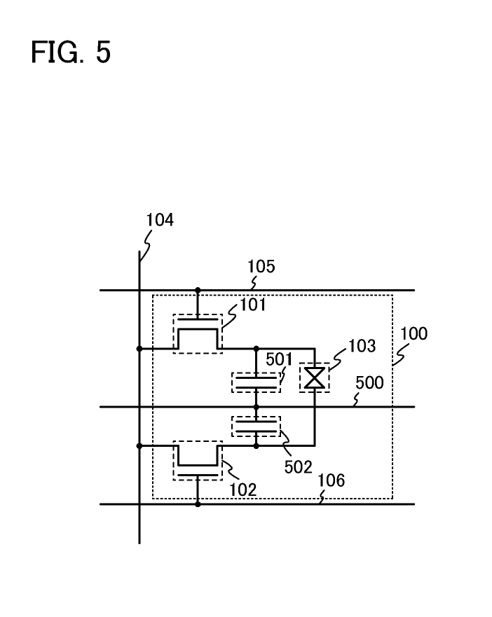

A structure in which a first capacitor for holding the potential PE of the first electrode and a second capacitor for holding the potential CE of the second electrode are additionally provided to the structure illustrated in FIG. 1A is described with reference to FIG. 5. FIG. 5 illustrates a structure in which a capacitor wiring 500 is additionally provided to the structure in FIG. 1A. A first capacitor 501 is formed using the capacitor wiring 500 and the first electrode of the liquid crystal element 103, and a second capacitor 502 is formed using the capacitor wiring 500 and the second electrode of the liquid crystal element 103.

Note that the first capacitor 501 and the second capacitor 502 can be formed using the first scan line 105 or the second scan line 106 in another row (e.g., the previous row or the second previous row) and the first electrode or the second electrode.

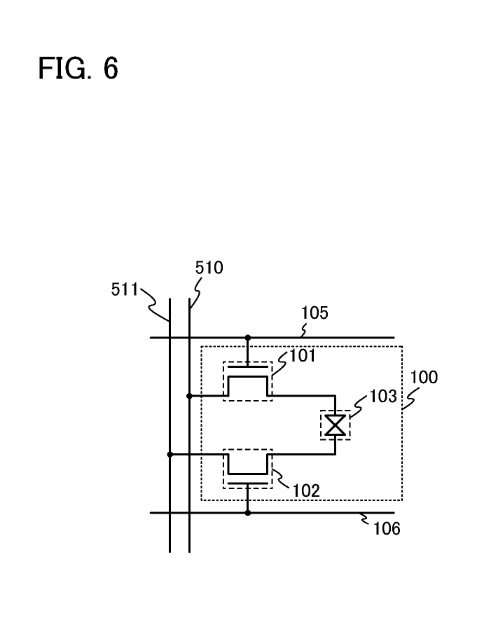

Next, a structure in which a video signal line and a common potential line are additionally provided instead of the signal line 104 in FIG. 1A is described with reference to FIG. 6. FIG. 6 illustrates a structure in which a video signal line 510 and a common potential line 511 are provided in stead of the signal line 104 in FIG. 1A. The video signal is supplied to the video signal line 510 and the common potential is supplied to the common potential line 511. The video signal line 510 is connected to the first terminal of the first transistor 101. The common potential line 511 is connected to the first terminal of the second transistor 102.

Note that the first capacitor 501 and the second capacitor 502 illustrated in FIG. 5 can be formed using the common potential line 511 in FIG. 6 and the first electrode or the second electrode.

This embodiment can be implemented in appropriate combination with any of the structures described in the other embodiments.

### Embodiment 4

In this embodiment, a structure of a display panel of a liquid crystal display device including the pixel described in Embodiment 1 with reference to FIG. 1A will be described.

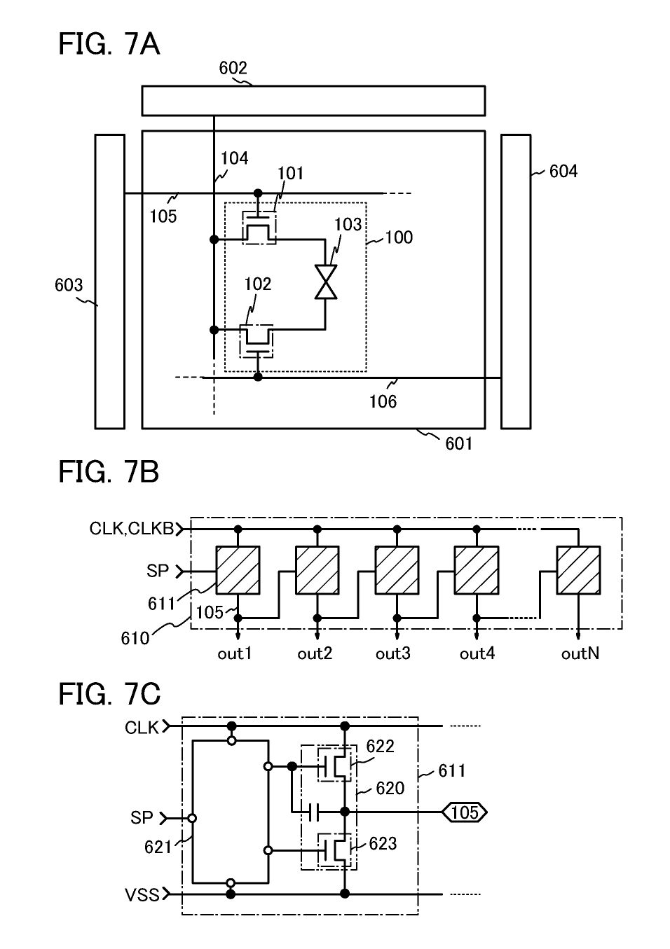

FIG. 7A is a schematic diagram of the display panel. The display panel illustrated in FIG. 7A includes a pixel portion 601 provided with a plurality of pixels 100 including the first transistor 101, the second transistor 102, and the liquid crystal element 103; a signal line driver circuit 602 for driving a plurality of signal lines 104, a first scan line driver circuit 603 for driving a plurality of first scan lines 105, and a second scan line driver circuit 604 for driving a plurality of second scan lines 106.

Note that the signal line driver circuit 602, the first scan line driver circuit 603, and the second scan line driver circuit 604 are preferably formed over the same substrate as the pixel portion 601, though not necessary. The signal line driver circuit 602, the first scan line driver circuit 603, and the second scan line driver circuit 604 are formed over the same substrate as the pixel portion 601, whereby the number of terminals for connecting with the outside can be reduced; therefore, the liquid crystal display device can be small.

Note that the pixels 100 are provided (arranged) in matrix. Here, description that pixels are provided (arranged) in matrix includes the case where the pixels are arranged in a straight line and the case where the pixels are arranged in a jagged line, in a longitudinal direction or a lateral direction.

FIG. 7B illustrates a structure example of a shift register circuit included in the first scan line driver circuit 603 (or the second scan line driver circuit 604) for driving the plurality of first scan lines 105 (or second scan lines 106). A shift register circuit 610 illustrated in FIG. 7B sequentially supplies scan signals applied to gates of the first transistors 101 (or the second transistors 102) in accordance with a timing signal such as a clock signal CLK, an inverted clock signal CLKB, and a start pulse SP, from a plurality of output terminals out1 to outN (N is a natural number) of a plurality of pulse output circuits 611, that is, from the first scan lines 105 (or the second scan lines 106), for example.

In the case where a transistor forming the pulse output circuit 611 in FIG. 7B is formed over the same substrate as the first transistor 101 and the second transistor 102 of the pixel 100 in the pixel portion 601, the pulse output circuit 611 has only n-channel transistors or p-channel transistors (hereinafter, a circuit which is formed using only n-channel transistors or p-channel transistors). FIG. 7C illustrates a simple structure of the pulse output circuit 611 which has only n-channel transistors or p-channel transistors.

The pulse output circuit 611 which has only n-channel transistors or p-channel transistors and which is illustrated in FIG. 7C is roughly divided into a buffer portion 620 and a control circuit portion 621 for controlling the buffer portion. The buffer portion 620 has a pull-up transistor 622 and a pull-down transistor 623 which have the same polarity. The pull-up transistor 622 performs bootstrap operation in accordance with the control of the control circuit portion 621 and can supply a signal corresponding to the high-level potential of the clock signal CLK to the first scan line 105 (or the second scan line 106). Accordingly, in the case where a signal with a high potential is supplied to the first scan line 105 (or the second scan line 106), higher potential is applied to a gate of the pull-up transistor 622 because of the bootstrap operation. With the structure of Embodiment 1, the amplitude voltage of the scan signal of the first scan line 105 (or the second scan line 106) can be low. Thus, the high potential applied to the gate of the pull-up transistor 622 can be reduced; therefore, deterioration of the shift register circuit can be reduced with the use of a circuit which has only n-channel transistors or p-channel transistors.

This embodiment can be implemented in appropriate combination with any of the structures described in the other embodiments.

### Embodiment 5

In this embodiment, a plurality of pixel structures, which is described in Embodiment 1 with reference to FIG. 1A, for performing the inversion driving will be described.

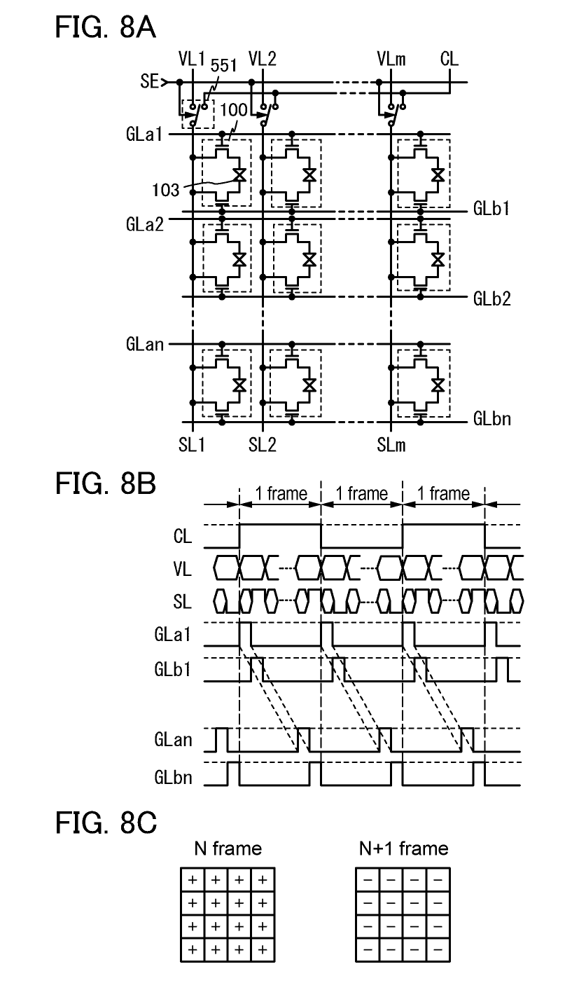

First, FIGS. 8A to 8C shows a circuit diagram, a timing diagram, and a schematic diagram in performing frame inversion driving which is described. FIG. 8A is a circuit diagram in which the pixels 100 are arranged in matrix. In FIG. 8A, a plurality of first scan lines is denoted by GLa1 to GLan (n is an arbitral natural number), a plurality of second scan lines is denoted by GLb1 to GLbn, a plurality of video signal lines is denoted by VL1 to VLm (m is an arbitral natural number), and a plurality of signal lines is denoted by SL1 to SLm. Note that in the circuit diagram, the common potential supplied from the common potential line CL is the same in all of the pixels. The video signal from the video signal line (VL) or the common potential from the common potential line CL is supplied to a plurality of signal lines SL1 to SLm in accordance with operation of a switching element 551.

FIG. 8B is a timing diagram for describing the circuit diagram in FIG. 8A. In the case of the frame inversion driving, the potentials of the common potential line CL are inverted every one frame. In addition, the potentials of the video signal in accordance with a grayscale are sequentially supplied to the video signal line VL as the potentials which are inverted by the inversion driving. Further, the common potential line CL or the video signal line VL is connected to the signal line SL by switching of the switching element 551, whereby the signal line is supplied with the signal in which the potential of the video signal and the common potential are switched. Specifically, the switching element 551 controls so that the video signal is supplied to the signal line SL at the timing when the first scan lines GLa1 to GLan go to a high-level potential, and the common potential is supplied to the signal line SL at the timing when the second scan lines GLb1 to GLbn go to the high-level potential.

The schematic diagram of FIG. 8C shows the scene where the polarity of a voltage applied between the first electrode and second electrode of the liquid crystal element 103 (shown as + or − in the diagram) changes between positive and negative every frame during continuous frames: an N-th frame (N is any natural number) and a (N+1)-th frame. This is, what is called, the frame inversion driving.

Note that a driving method illustrated in FIG. 8B may be a method in which the potential of the common potential line CL may vary per a plurality of frames (e.g., per two or three frames). In this case, the polarity of voltage applied between the first electrode and the second electrode of the liquid crystal element 103 is switched per a plurality of frames. Thus, power consumption of the liquid crystal display device can be reduced.

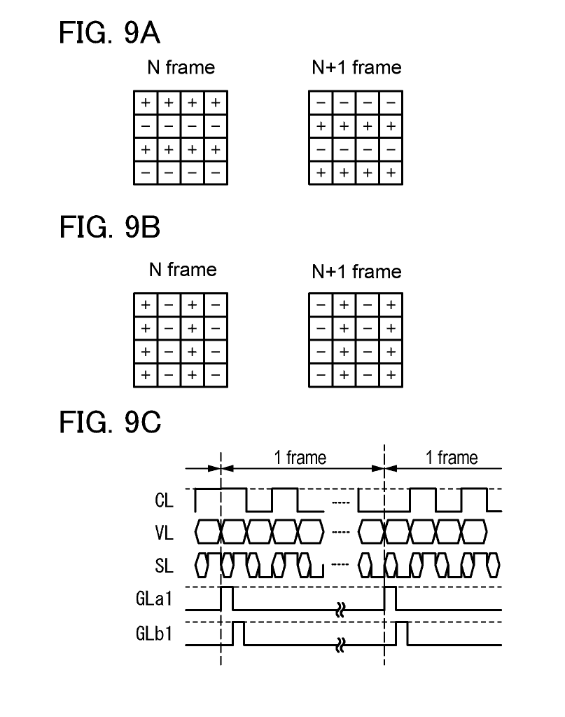

In FIGS. 8A to 8C, an example of the frame inversion driving is described. Note that gate line inversion driving illustrated in a schematic diagram in FIG. 9A, source line inversion driving illustrated in a schematic diagram in FIG. 9B, or dot inversion driving not illustrated can be performed. Here, the gate line inversion driving is described with reference to a timing diagram. Note that the circuit diagram in FIG. 8A is used for a circuit diagram for the description.

FIG. 9C is a timing diagram which illustrates operation of a circuit shown in FIG. 8A in the case where the circuit is driven by the gate line inversion driving. In the case of the gate line inversion driving, the potentials of the common potential line CL are inverted every one gate selection period. In addition, the potentials used for the inversion driving are sequentially supplied to the video signal line VL. The potentials are the potentials of the video signal in accordance with a grayscale. Further, the common potential line CL or the video signal line VL are connected to the signal line SL in accordance with switching the switching element 551, whereby the signal line is supplied with the signal in which the potential of the video signal and the common potential are switched. Specifically, the switching element 551 controls so that the video signal is supplied to the signal line SL at the timing when the first scan lines GLa1 to GLan go to the high-level potential, and the common potential is supplied to the signal line SL at the timing when the second scan lines GLb1 to GLbn go to the high-level potential.

Note that the driving method illustrated in FIG. 9C may be a method in which the potential of the common potential line CL may vary per a plurality of gate selection periods (e.g., per two or three gate selection periods). In this case, positive voltage and negative voltage are alternately applied to the liquid crystal element 103 for a plularity of rows. Thus, power consumption can be reduced.

This embodiment can be implemented in appropriate combination with any of the structures described in the other embodiments.

### Embodiment 6

In this embodiment, an example of a plane view and a cross-sectional view of a pixel in a display panel of a liquid crystal display device will be described with reference to drawings.

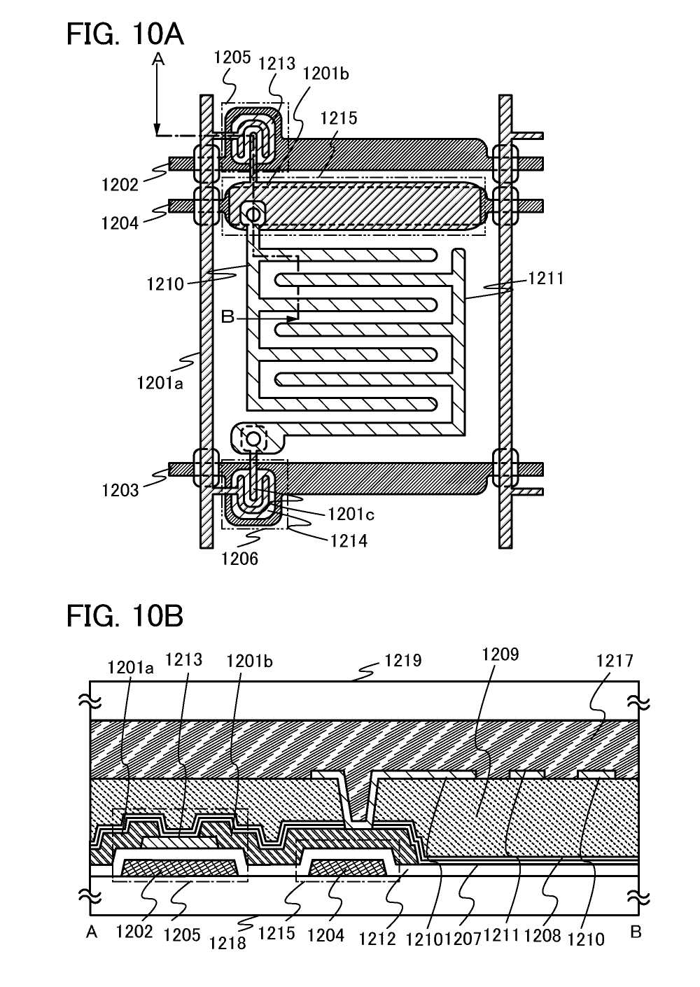

FIG. 10A is a plan view of one of pixels included in the display panel. FIG. 10B is a cross-sectional view taken along the alternate long and short dashed line A-B of FIG. 10A.

In FIG. 10A, wiring layers (including a source electrode layer 1201a, a drain electrode layer 1201b and a drain electrode layer 1201c) which are the signal lines are provided to be extended in a longitudinal direction (a column direction) in the drawing. A wiring layer (including a gate electrode layer 1202) which is the first scan line is provided to be extended in a horizontal direction (a row direction) in the drawing. A wiring layer (including a gate electrode layer 1203) which is the second scan line is provided to be approximately orthogonal to the source electrode layer 1201a (to be extended in a horizontal (row) direction) in the drawing. A capacitor wiring layer 1204 is provided to be extended approximately parallel to the gate electrode layer 1202 and the gate electrode layer 1203, and approximately orthogonally to the source electrode layer 1201a.

In a pixel of the display panel illustrated in FIG. 10A, a first transistor 1205 including the gate electrode layer 1202 and a second transistor 1206 including the gate electrode layer 1203 are provided apart from each other. An insulating film 1207 and an insulating film 1208 and an interlayer film 1209 are provided over the first transistor 1205 and the second transistor 1206.

The pixel of the display panel illustrated in FIGS. 10A and 10B includes the transparent electrode layer 1210 as a first electrode layer connected to the first transistor 1205, and a transparent electrode layer 1211 as a second electrode layer connected to the second transistor 1206. The transparent electrode layer 1210 and the transparent electrode layer 1211 has a comb shape and are provided apart from each other so as to engage with each other. An opening (a contact hole) is formed in the insulating film 1207, the insulating film 1208, and the interlayer film 1209 which are over the first transistor 1205 and the second transistor 1206. In the opening (a contact hole), a transparent electrode layer 1210 and the first transistor 1205 are connected. In another opening (a contact hole), the transparent electrode layer 1211 and the second transistor 1206 are connected.

The first transistor 1205 illustrated in FIGS. 10A and 10B includes a first semiconductor layer 1213 provided over the gate electrode layer 1202 with a gate insulating layer 1212 therebetween, and the source electrode layer 1201a and the drain electrode layer 1201b are in contact with the first semiconductor layer 1213. The second transistor 1206 illustrated in FIG. 10A includes a second semiconductor layer 1214 provided over the gate electrode layer 1203 with the gate insulating layer 1212 therebetween, and the source electrode layer 1201a and a drain electrode layer 1202c are in contact with the second semiconductor layer 1214. In addition, the capacitor wiring layer 1204, the gate insulating layer 1212, and the drain electrode layer 1201b are stacked to form a capacitor 1215.

Note that as illustrated in FIG. 10A, with the structure in which the capacitor 1215 is provided, the current supply capability of the first transistor 1205 is preferably larger than that of the second transistor 1206. Specifically, the ratio of the channel width (W) to the channel length (L) (W/L) of the first transistor 1205 is larger than that of the second transistor 1206. In the case where the W/L of the first transistor 1205 is larger than that of the second transistor 1206, the charging rate of the capacitor 1215 is high and rising edge of the potential of the transparent electrode layer 1210 corresponding to the first electrode of the liquid crystal element can be sharp.

Further, a first substrate 1218 and a second substrate 1219 are provided so as to overlap with each other with the first transistor 1205, the second transistor 1206, and a liquid crystal layer 1217 provided therebetween.

FIG. 10B shows an example of using an inverted-staggered transistor with a bottom-gate structure as the first transistor 1205. Note that a structure of the transistor which can be applied to a liquid crystal display device disclosed in this specification is not particularly limited. For example, transistor with a top-gate structure in which a gate electrode layer is provided over a semiconductor layer with a gate insulating layer provided therebetween, and a staggered transistor with a bottom-gate structure and a planar transistor in which a gate electrode layer is provided below a semiconductor layer with a gate insulating layer provided therebetween.

This embodiment can be implemented in appropriate combination with any of the structures described in the other embodiments.

### Embodiment 7

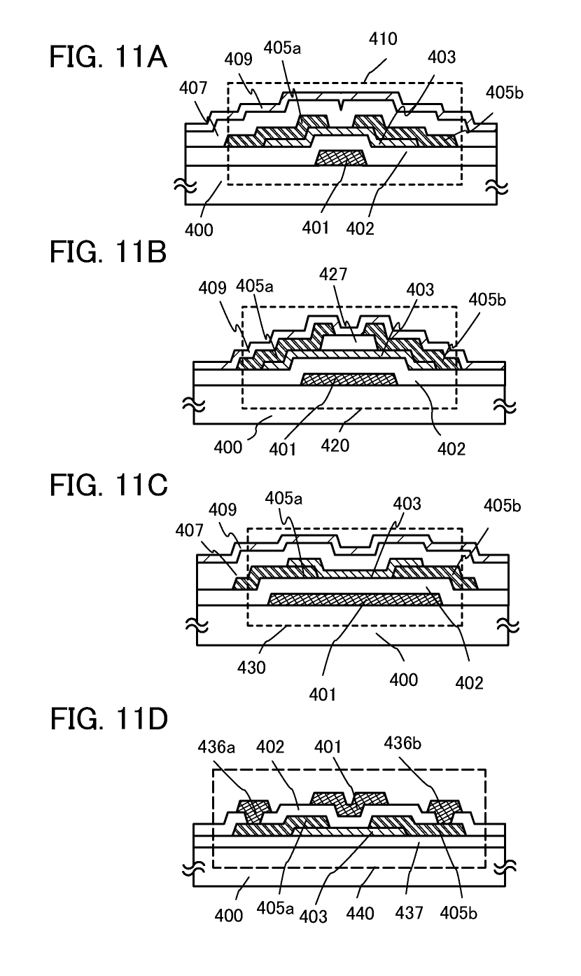

In this embodiment, an example of a transistor that can be applied to a liquid crystal display device disclosed in this specification will be described. There is no particular limitation on a structure of the transistor that can be applied to the liquid crystal display device disclosed in this specification. For example, a staggered transistor, a planar transistor, or the like having a top-gate structure in which a gate electrode is provided above an oxide semiconductor layer with a gate insulating layer interposed or a bottom-gate structure in which a gate electrode is provided below an oxide semiconductor layer with a gate insulating layer interposed, can be used. Further, the transistor may have a single gate structure including one channel formation region, a double gate structure including two channel formation regions, or a triple gate structure including three channel formation regions. Alternatively, the transistor may have a dual gate structure including two gate electrode layers positioned over and below a channel region with a gate insulating layer provided therebetween. Note that examples of a cross-sectional structure of a transistor illustrated FIGS. 11A to 11D are described below.

Note that each of the transistors illustrated in FIGS. 11A to 11D includes an oxide semiconductor as a semiconductor layer. An advantage of using an oxide semiconductor is that high field-effect mobility (the maximum value is 5 cm²/Vsec or higher, preferably in the range of 10 cm²/Vsec to 150 cm²/Vsec) can be obtained when a transistor is on, and low off-state current (for example, off-state current per channel width is lower than 1 aA/μm, preferably lower than 10 zA/μm and lower than 100 zA/μm at 85° C.) can be obtained when the transistor is off.

A transistor 410 illustrated in FIG. 11A is one of bottom-gate transistors and is also referred to as an inverted-staggered transistor.

The transistor 410 includes, over a substrate 400 having an insulating surface, a gate electrode layer 401, a gate insulating layer 402, an oxide semiconductor layer 403, a source electrode layer 405a, and a drain electrode layer 405b. In addition, the insulating film 407 which covers the transistor 410 and is stacked over the oxide semiconductor layer 403 is provided. A protective insulating layer 409 is formed over the insulating film 407.

A transistor 420 illustrated in FIG. 11B is one of bottom-gate transistors referred to as a channel-protective type (also referred to as a channel-stop type) and is also referred to as an inverted-staggered transistor.

The transistor 420 includes, over the substrate 400 having an insulating surface, the gate electrode layer 401, the gate insulating layer 402, the oxide semiconductor layer 403, an insulating layer 427 which functions as a channel protective layer covering a channel formation region of the oxide semiconductor layer 403, the source electrode layer 405a, and the drain electrode layer 405b. Further, the protective insulating layer 409 is formed so as to cover the transistor 420.

A transistor 430 illustrated in FIG. 11C is a bottom-gate transistor and includes, over the substrate 400 having an insulating surface, the gate electrode layer 401, the gate insulating layer 402, the source electrode layer 405a, the drain electrode layer 405b, and the oxide semiconductor layer 403. The insulating film 407 which covers the transistor 430 and is in contact with the oxide semiconductor layer 403 is provided. A protective insulating layer 409 is formed over the insulating film 407.

In the transistor 430, the gate insulating layer 402 is provided over and in contact with the substrate 400 and the gate electrode layer 401; the source electrode layer 405a and the drain electrode layer 405b are provided over and in contact with the gate insulating layer 402. Further, the oxide semiconductor layer 403 is provided over the gate insulating layer 402, the source electrode layer 405a, and the drain electrode layer 405b.

A transistor 440 illustrated in FIG. 11D is one of top-gate transistors. The transistor 440 includes, over the substrate 400 having an insulating surface, an insulating layer 437, the oxide semiconductor layer 403, the source electrode layer 405a, the drain electrode layer 405b, the gate insulating layer 402, and the gate electrode layer 401. A wiring layer 436a and a wiring layer 436b are formed in contact with and are connected to the source electrode layer 405a and the drain electrode layer 405b respectively.

In this embodiment, as described above, the oxide semiconductor layer 403 is used as a semiconductor layer. As an oxide semiconductor used for the oxide semiconductor layer 403, the following metal oxides can be used: a four-component metal oxide such as an In—Sn—Ga—Zn—O-based oxide semiconductor; a three-component metal oxide such as an In—Ga—Zn—O-based oxide semiconductor, an In—Sn—Zn—O-based oxide semiconductor, an In—Al—Zn—O-based oxide semiconductor, a Sn—Ga—Zn—O-based oxide semiconductor, an Al—Ga—Zn—O-based oxide semiconductor, and a Sn—Al—Zn—O-based oxide semiconductor; a two-component metal oxide such as an In—Zn—O-based oxide semiconductor, a Sn—Zn—O-based oxide semiconductor, an Al—Zn—O-based oxide semiconductor, a Zn—Mg—O-based oxide semiconductor, a Sn—Mg—O-based oxide semiconductor, and an In—Mg—O-based oxide semiconductor; an In—Ga—O-based oxide semiconductor, an In—O-based oxide semiconductor; a Sn—O-based oxide semiconductor; a Zn—O-based oxide semiconductor. Further, SiO₂ may be contained in the above oxide semiconductor. In this specification, for example, an In—Ga—Zn—O-based oxide semiconductor means an oxide film containing indium (In), gallium (Ga), and zinc (Zn), and there is no particular limitation on the composition ratio. The In—Ga—Zn—O-based oxide semiconductor may contain an element other than In, Ga, and Zn.

As the oxide semiconductor layer 403, a thin film of a material represented by InMO₃ (ZnO)ₘ (m>0) can be used. Here, M represents one or more metal elements selected from Zn, Ga, Al, Mn, or Co. For example, M can be Ga, Ga and Al, Ga and Mn, Ga and Co, or the like.

In the case where an In—Zn—O-based material is used as an oxide semiconductor, a target therefor has a composition ratio of In:Zn=50:1 to 1:2 in an atomic ratio (In₂O₃:ZnO=25:1 to 1:4 in a molar ratio), preferably, In:Zn=20:1 to 1:1 in an atomic ratio (In₂O₃:ZnO=10:1 to 1:2 in a molar ratio), further preferably, In:Zn=15:1 to 1.5:1 in an atomic ratio (In₂O₃: ZnO=15:2 to 3:4 in a molar ratio). For example, in a target used for formation of an In—Zn—O-based oxide semiconductor which has an atomic ratio of In:Zn:O=X:Y:Z, the relation of Z>1.5X+Y is satisfied.

In each of the transistors 410, 420, 430, and 440 which use the oxide semiconductor layer 403, the amount of current in an off state (off-state current) can be small. Thus, in a pixel, a capacitor for holding an electric signal such as an video signal can be designed to be smaller. Accordingly, the aperture ratio of the pixel can be increased, so that power consumption can be suppressed.

In addition, each of the transistors 410, 420, 430, and 440 including the oxide semiconductor layer 403 has low off-state current. Accordingly, an electrical signal such as the video signal can be held for a longer time in the pixel, and a writing interval can be set longer. Therefore, the cycle of one frame period can be set longer, and the frequency of refresh operations in a still image display period can be reduced, whereby an effect of suppressing power consumption can be further increased. In addition, since the transistors can be separately provided in a driver circuit portion and a pixel portion over one substrate, the number of components of the liquid crystal display device can be reduced.

Although there is no particular limitation on a substrate that can be used as the substrate 400 having an insulating surface, a glass substrate made of barium borosilicate glass, aluminoborosilicate glass, or the like can be used.

In the bottom-gate structure transistors 410, 420, and 430, an insulating film serving as a base film may be provided between the substrate and the gate electrode layer. The base film has a function of preventing diffusion of an impurity element from the substrate, and can be formed to have a single-layer structure or a stacked structure using one or more of a silicon nitride film, a silicon oxide film, a silicon nitride oxide film, and a silicon oxynitride film.

The gate electrode layer 401 can be formed to have a single-layer or stacked-layer structure using a metal material such as molybdenum, titanium, chromium, tantalum, tungsten, aluminum, copper, neodymium, or scandium, or an alloy material which contains any of these materials as its main component.

The gate insulating layer 402 can be formed with a single-layer structure or a layered structure using any of a silicon oxide layer, a silicon nitride layer, a silicon oxynitride layer, a silicon nitride oxide layer, an aluminum oxide layer, an aluminum nitride layer, an aluminum oxynitride layer, an aluminum nitride oxide layer, and a hafnium oxide layer by a plasma CVD method, a sputtering method, or the like. For example, by a plasma CVD method, a silicon nitride layer (SiN_{y} (y>0)) with a thickness of greater than or equal to 50 nm and less than or equal to 200 nm is formed as a first gate insulating layer, and a silicon oxide layer (SiOₓ (x>0)) with a thickness of greater than or equal to 5 nm and less than or equal to 300 nm is formed as a second gate insulating layer over the first gate insulating layer, so that a gate insulating layer with a total thickness of 200 nm is formed.

As a conductive film used for the source electrode layer 405a and the drain electrode layer 405b, for example, a metal film containing an element selected from Al, Cr, Cu, Ta, Ti, Mo, and W and a metal nitride film containing any of the above elements as its main component (a titanium nitride film, a molybdenum nitride film, and a tungsten nitride film) can be used. A metal film having a high melting point such as Ti, Mo, W, or the like or a metal nitride film of any of these elements (a titanium nitride film, a molybdenum nitride film, and a tungsten nitride film) may be stacked on one of or both of a lower side or an upper side of a metal film of Al, Cu, or the like.

A material similar to that for the source electrode layer 405a and the drain electrode layer 405b can be used for a conductive film used for the wiring layer 436a and the wiring layer 436b which are respectively connected to the source electrode layer 405a and the drain electrode layer 405b.

Alternatively, the conductive film to be the source and drain electrode layers 405a and 405b (including a wiring layer formed using the same layer as the source and drain electrode layers) may be formed using conductive metal oxide. As conductive metal oxide, indium oxide (In₂O₃), tin oxide (SnO₂), zinc oxide (ZnO), indium oxide-tin oxide alloy (In₂O₃—SnO₂; abbreviated to ITO), indium oxide-zinc oxide alloy (In₂O₃—ZnO), or any of these metal oxide materials in which silicon or silicon oxide is contained can be used.

As the insulating films 407 and 427 provided over the oxide semiconductor layer, and the insulating layer 437 provided under the oxide semiconductor layer, an inorganic insulating film such as a silicon oxide film, a silicon oxynitride film, an aluminum oxide film, an aluminum oxynitride film, or the like can be typically used.

For the protective insulating layer 409 provided over the oxide semiconductor layer, an inorganic insulating film such as a silicon nitride film, an aluminum nitride film, a silicon nitride oxide film, or an aluminum nitride oxide film can be used.

Further, a planarization insulating film may be formed over the protective insulating layer 409 so that surface roughness due to the transistor is reduced. For the planarization insulating film, an organic material such as polyimide, acrylic, or benzocyclobutene can be used. Other than such organic materials, it is also possible to use a low-dielectric constant material (a low-k material) or the like. Note that the planarization insulating film may be formed by stacking a plurality of insulating films formed from these materials.

As described above, a transistor which is fabricated in a manner illustrated in this embodiment includes a highly-purified oxide semiconductor layer. Such a transistor can have low off-state current. Accordingly, an electrical signal such as the video signal can be held for a longer time in the pixel, and a writing interval can be set longer. Therefore, the cycle of one frame period can be set longer, and the frequency of refresh operations in a still image display period can be reduced, whereby an effect of suppressing power consumption can be further increased. In addition, a highly-purified oxide semiconductor layer is preferably used because such a layer can be manufactured without a process such as laser irradiation and can realize formation of a transistor over a large substrate.

This embodiment can be implemented in appropriate combination with any of the structures described in the other embodiments.

### Embodiment 8

A liquid crystal display device disclosed in this specification can be applied to a variety of electronic appliances (including game machines). Examples of electronic appliances are a television set (also referred to as a television or a television receiver), a monitor of a computer or the like, a camera such as a digital camera or a digital video camera, a digital photo frame, a mobile phone handset (also referred to as a mobile phone or a mobile phone device), a portable game machine, a portable information terminal, an audio reproducing device, a large-sized game machine such as a pachinko machine, and the like. Examples of electronic devices each including the liquid crystal display device described in the above embodiment are described.

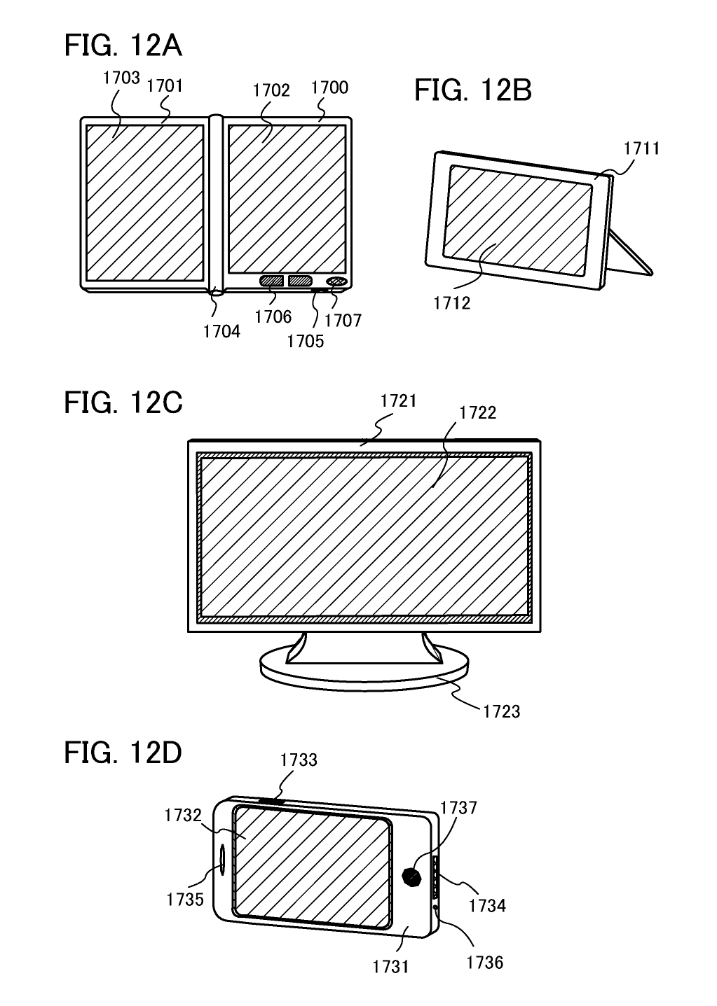

FIG. 12A illustrates an example of the electronic book device. The e-book reader illustrated in FIG. 12A includes two housings, a housing 1700 and a housing 1701. The housing 1700 and the housing 1701 are combined with a hinge 1704 so that the electronic book reader can be opened and closed. With such a structure, the e-book reader can be operated like a paper book.

A display portion 1702 and a display portion 1703 are incorporated in the housing 1700 and the housing 1701, respectively. The display portion 1702 and the display portion 1703 may be configured to display one image or different images. In the case where the display portion 1702 and the display portion 1703 display different images, for example, a display portion on the right side (the display portion 1702 in FIG. 12A) can display text and a display portion on the left side (the display portion 1703 in FIG. 12A) can display graphics.

FIG. 12A illustrates an example in which the housing 1700 is provided with an operation portion and the like. For example, the housing 1700 is provided with a power supply input terminal 1705, an operation key 1706, a speaker 1707, and the like. With the operation key 1706, pages can be turned. Note that a keyboard, a pointing device, or the like may be provided on the surface of the housing, on which the display portion is provided. Further, an external connection terminal (an earphone terminal, a USB terminal, a terminal that can be connected to various cables such as a USB cable, or the like), a recording medium insert portion, or the like may be provided on the back surface or the side surface of the housing. Further, the electronic book device illustrated in FIG. 12A may have a function of an electronic dictionary.

FIG. 12B illustrates an example of a digital photo frame including a liquid crystal display device. For example, in the digital photo frame illustrated in FIG. 12B, a display portion 1712 is incorporated in a housing 1711. The display portion 1712 can display various images. For example, the display portion 1712 can display data of an image taken with a digital camera or the like and function as a normal photo frame.

Note that the digital photo frame illustrated in FIG. 12B is provided with an operation portion, an external connection terminal (a USB terminal, a terminal that can be connected to various cables such as a USB cable, or the like), a recording medium insertion portion, and the like. Although these components may be provided on the surface on which the display portion is provided, it is preferable to provide them on the side surface or the back surface for the design of the digital photo frame 9700. For example, a memory storing data of an image taken with a digital camera is inserted in the recording medium insertion portion of the digital photo frame, whereby the image data can be transferred and then displayed on the display portion 1712.

FIG. 12C illustrates an example of a television set in which a display device such as a liquid crystal display device or a light-emitting display device is used. In the television set illustrated in FIG. 12C, a display portion 1722 is incorporated in a housing 1721. The display portion 1722 can display an image. Further, the housing 1721 is supported by a stand 1723 here. The liquid crystal display device described in any of the above embodiments can be used in the display portion 1722.

The television set illustrated in FIG. 12C can be operated by an operation switch of the housing 1721 or a separate remote controller. Channels and volume can be controlled with an operation key of the remote controller so that an image displayed on the display portion 1722 can be controlled. Further, the remote controller may be provided with a display portion for displaying data output from the remote controller.

FIG. 12D illustrates an example of a mobile phone including a liquid crystal display device. The mobile phone handset illustrated in FIG. 12D includes a display portion 1732 incorporated in a housing 1731, operation buttons 1733 and 1737, an external connection port 1734, a speaker 1735, a microphone 1736, and the like.

The display portion 1732 of the mobile phone handset illustrated in FIG. 12D is a touchscreen. When the display portion 1732 is touched with a finger or the like, contents displayed on the display portion 1732 can be controlled. Further, operations such as making calls and composing mails can be performed by touching the display portion 1732 with a finger or the like.

This embodiment can be implemented in appropriate combination with any of the structures described in the other embodiments.

This application is based on Japanese Patent Application serial no. 2010-117017 filed with Japan Patent Office on May 21, 2010, the entire contents of which are hereby incorporated by reference.

What is claimed is:

1. A liquid crystal display device comprising:
a first transistor comprising a gate electrically connected to a first scan line, a first terminal electrically connected to a signal line, and a second terminal electrically connected to a first electrode of a liquid crystal element; and
a second transistor comprising a gate electrically connected to a second scan line, a first terminal electrically connected to the signal line, and a second terminal electrically connected to a second electrode of the liquid crystal element,
wherein a video signal for inversion driving of the liquid crystal element is supplied from the signal line to the first electrode through the first transistor, and
wherein a common potential for the inversion driving of the liquid crystal element is supplied from the signal line to the second electrode through the second transistor.

2. The liquid crystal display device according to claim 1, wherein the inversion driving is gate line inversion driving.

3. The liquid crystal display device according to claim 1, wherein the inversion driving is source line inversion driving.

4. An electronic device comprising the liquid crystal display device according to claim 1.

5. A liquid crystal display device comprising:
a first transistor comprising a gate electrically connected to a first scan line, a first terminal electrically connected to a signal line, and a second terminal electrically connected to a first electrode of a liquid crystal element;
a second transistor comprising a gate electrically connected to a second scan line, a first terminal electrically connected to the signal line, and a second terminal electrically connected to a second electrode of the liquid crystal element; and
a capacitor comprising a first electrode electrically connected to the first electrode of the liquid crystal element,
wherein a video signal for inversion driving of the liquid crystal element is supplied from the signal line to the first electrode through the first transistor, and
wherein a common potential for the inversion driving of the liquid crystal element is supplied from the signal line to the second electrode through the second transistor.

6. The liquid crystal display device according to claim 5, wherein the capacitor comprises a second electrode supplied with a predetermined potential.

7. The liquid crystal display device according to claim 5, wherein the capacitor comprises a second electrode that is a part of a capacitor wiring.

8. The liquid crystal display device according to claim 5, wherein the inversion driving is gate line inversion driving.

9. The liquid crystal display device according to claim 5, wherein the inversion driving is source line inversion driving.

10. An electronic device comprising the liquid crystal display device according to claim 5.

11. A liquid crystal display device comprising:
a first transistor comprising a gate electrically connected to a first scan line, a first terminal electrically connected to a signal line, and a second terminal electrically connected to a first electrode of a liquid crystal element;
a second transistor comprising a gate electrically connected to a second scan line, a first terminal electrically connected to the signal line, and a second terminal electrically connected to a second electrode of the liquid crystal element;
a first capacitor comprising a first electrode electrically connected to the first electrode of the liquid crystal element; and
a second capacitor comprising a first electrode electrically connected to the second electrode of the liquid crystal element,
wherein a video signal for inversion driving of the liquid crystal element is supplied from the signal line to the first electrode through the first transistor, and
wherein a common potential for the inversion driving of the liquid crystal element is supplied from the signal line to the second electrode through the second transistor.

12. The liquid crystal display device according to claim 11, wherein the first capacitor and the second capacitor each comprise a second electrode supplied with a predetermined potential.

13. The liquid crystal display device according to claim 11, wherein the first capacitor and the second capacitor each comprise a second electrode that is a part of a capacitor wiring.

14. The liquid crystal display device according to claim 11, wherein the inversion driving is gate line inversion driving.

15. The liquid crystal display device according to claim 11, wherein the inversion driving is source line inversion driving.

16. An electronic device comprising the liquid crystal display device according to claim 11.

17. A liquid crystal display device comprising:
a first transistor comprising a gate electrically connected to a first scan line, a first terminal electrically connected to a signal line, and a second terminal electrically connected to a first electrode of a liquid crystal element; and
a second transistor comprising a gate electrically connected to a second scan line, a first terminal electrically connected to a common potential line, and a second terminal electrically connected to a second electrode of the liquid crystal element,
wherein a video signal for inversion driving of the liquid crystal element is supplied from the signal line to the first electrode through the first transistor, and
wherein a common potential for the inversion driving of the liquid crystal element is supplied from the common potential line to the second electrode through the second transistor.

18. The liquid crystal display device according to claim 17, wherein the inversion driving is gate line inversion driving.

19. The liquid crystal display device according to claim 17, wherein the inversion driving is source line inversion driving.

20. An electronic device comprising the liquid crystal display device according to claim 17.
